(19) United States
(12) Patent Application Publication
(10) Pub. No.: US 2025/0087158 A1
(43) Pub. Date: Mar. 13, 2025

(54) DISPLAY DEVICE AND METHOD FOR COMPENSATING FOR DEGRADATION THEREOF

(71) Applicant: LG Display Co., Ltd., Seoul (KR)

(72) Inventors: Injune KIM, Seoul (KR); Hyebin YANG, Seoul (KR)

(73) Assignee: LG Display Co., Ltd., Seoul (KR)

(21) Appl. No.: 18/808,937

(22) Filed: Aug. 19, 2024

(30) Foreign Application Priority Data
Sep. 7, 2023 (KR) 10-2023-0119213

(51) Int. Cl. G09G 3/3233; G09G 3/3266

(52) U.S. Cl. CPC G09G 3/3233; G09G 3/3266; G09G 2300/0819; G09G 2300/0842; G09G 2310/0286; G09G 2310/08; G09G 2320/0233

(57) ABSTRACT

A display device can include a display panel including a plurality of pixels, a data driver configured to apply a reference data voltage to the display panel in a sensing mode, a current sensor configured to, in the sensing mode, lower a high potential driving voltage supplied to the display panel, sense a driving current of the display panel while the reference data voltage and the lowered driving voltage are applied and convert the sensed driving current into sensing data. Additionally, the display device includes a controller configured to calculate a compensation factor based on the sensing data. Further, in a display mode, the compensation factor is used to compensate image data. In addition, provided is a method for compensating for degradation of a display device.

### CROSS-REFERENCE TO RELATED APPLICATION

This application claims priority to Korean Patent Application No. 10-2023-0119213, filed on Sep. 7, 2023 in the Republic of Korea, which is hereby incorporated by reference into the present application.

### BACKGROUND

### 1. Field

The present disclosure relates to a display device that compensates for degradation of a display panel and a method for compensating for degradation of a display panel.

### 2. Description of Related Art

Display devices used in computer monitors, TVs, mobile phones, etc. include organic light emitting display devices (OLED) that are configured to emit light on their own, and liquid crystal display devices (LCD) that require separate light sources.

A scope of application of display devices are becoming more diverse, ranging from computer monitors and TVs to personal portable devices. Research is being conducted on a display device that has a larger display area but a reduced volume and weight. However, there is a limitation that display devices will have degraded image quality over time.

To address this limitation, provided is a display device configured to compensate for a degraded image quality. This display device includes a data driving circuit that supplies data signals to data lines of the display panel, and a gate driving circuit that supplies gate signals to gate lines of the display panel.

### SUMMARY OF THE DISCLOSURE

A purpose of the present disclosure is to provide a display device and a method for compensating for degradation thereof in which a driving current on a block basis of a display panel is separately sensed under a high current point and a low current point to generate first and second compensation factors corresponding to the high current point and a low current point, and threshold voltage characteristics and electron mobility characteristics of a driving transistor are respectively compensated for based on the first and second compensation factors.

Furthermore, a purpose of the present disclosure is to provide a display device and a method for compensating for degradation thereof in which both the threshold voltage and a mobility of the driving transistor are compensated for to reduce a degradation compensation error, thereby implementing accurate grayscale and luminance of an image.

Purposes according to the present disclosure are not limited to the above-mentioned purpose. Other purposes and advantages according to the present disclosure that are not mentioned can be understood based on following descriptions, and can be more clearly understood based on embodiments according to the present disclosure. Further, it will be easily understood that the purposes and advantages according to the present disclosure can be realized using means shown in the claims or combinations thereof, but are not limited thereto.

In order to achieve the above purpose, a display device according to one aspect of the present disclosure can include a display panel including a plurality of pixels, and a data driver configured to a reference data voltage to the display panel in a sensing mode, and a current sensor configured to in the sensing mode, lower a high potential driving voltage supplied to the display panel, sense a driving current of the display panel under the reference data voltage and the lowered driving voltage, and convert the sensed driving current into sensing data.

In order to achieve the above purpose, a method for compensating for degradation of a display device according to another aspect of the present disclosure can include in a sensing mode, applying a first reference data voltage corresponding to a low-current sensing point to a display panel, sensing a first driving current under the first reference data voltage, converting the first driving current into first sensing data, in the sensing mode, applying a second reference data voltage corresponding to a high current sensing point to the display panel, sensing a second driving current under the second reference data voltage, converting the second driving current into second sensing data, receptively calculating a first compensation factor and a second compensation factor for compensating for threshold voltage characteristics and electron mobility characteristics of a driving transistor, based on the first sensing data and the second sensing data, respectively, and in a display mode, generating compensation data based on the first compensation factor and the second compensation factor, and compensating for image data using the compensation data.

In order to achieve the above purpose, a display device according to still another aspect of the present disclosure can include a display panel including a plurality of pixels, and a current sensor configured to in a sensing mode, sense a driving current of the display panel under a reference data voltage on a preset block basis of the display panel, and convert the sensed driving current into sensing data, wherein each of the plurality of pixels can include a light-emitting element (LED) for emitting light in response to the driving current, a driving transistor configured to control the driving current and connected to and disposed between an anode electrode of the light-emitting element and a high-potential power line, a capacitor connected to and disposed between a gate electrode and a source electrode of the driving transistor, a first transistor configured to initialize the gate electrode of the driving transistor in response to an initialization signal, a second transistor configured to apply a data voltage corresponding to image data or the reference data voltage to the gate electrode of the driving transistor in response to a scan signal, and a third transistor configured to apply a reference voltage to the source electrode of the driving transistor in response to a sensing signal.

According to embodiments of the present disclosure, the degradation compensation error can be reduced by compensating for both the threshold voltage characteristics and the electron mobility characteristics of the driving transistor of the display panel.

Furthermore, according to embodiments of the present disclosure, spot defects in the display panel can be reduced by reducing the degradation compensation error on a block basis.

Furthermore, according to embodiments of the present disclosure, the influence of the threshold voltage characteristics and the electron mobility characteristics of the driving transistor can be reduced to display an image at accurate target gray scale and luminance. Accordingly, image quality of the display device can be improved.

Furthermore, according to embodiments of the present disclosure, the light-emitting element can operate with one driving transistor and three switching transistors which can be used for current sensing for degradation compensation. Thus, when the display device of the present disclosure is applied to a transparent display device, a transmissive area can be increased.

Effects of the present disclosure are not limited to the effects mentioned above, and other effects not mentioned will be clearly understood by those skilled in the art from the description below.

In addition to the above effects, specific effects of the present disclosure are described together while describing specific details for carrying out the present disclosure.

### BRIEF DESCRIPTION OF THE DRAWINGS

The present disclosure will become more fully understood from the detailed description given hereinbelow and the accompanying drawings which are given by way of illustration only, and thus are not limitative of the present disclosure.

FIG. 1 is a block diagram schematically showing a display device according to an embodiment of the present disclosure.

FIG. 2 is a cross-sectional view showing a stack structure of a display device according to an embodiment of the present disclosure.

FIG. 3 is a diagram of a configuration of a gate driver in a display device according to an embodiment of the present disclosure.

FIG. 4 is a plan view schematically showing a display device according to an embodiment of the present disclosure.

FIG. 5 is a pixel circuit diagram of a display device according to an embodiment of the present disclosure.

FIG. 6 is a diagram showing current sensing on a block basis of a display device according to an embodiment of the present disclosure.

FIG. 7 is a diagram showing current sensing of a pixel within a block unit of a display device according to an embodiment of the present disclosure.

FIG. 8A is a timing diagram showing a display mode operation of a pixel circuit of a display device according to an embodiment of the present disclosure.

FIG. 8B is a timing diagram showing a current sensing operation of a display device according to an embodiment of the present disclosure.

FIGS. 9 to 11 are diagrams schematically showing a principle of compensating for degradation characteristics of a display panel based on sensing data in a display device according to an embodiment of the present disclosure.

FIG. 12 is a flowchart showing a method for compensating for degradation of a display device according to an embodiment of the present disclosure.

### DETAILED DESCRIPTION OF THE EMBODIMENTS

Advantages and features of the present disclosure, and a method of achieving the advantages and features will become apparent with reference to embodiments described later in detail together with the accompanying drawings. However, the present disclosure is not limited to the embodiments as disclosed under, but can be implemented in various different forms. Thus, these embodiments are set forth only to make the present disclosure complete, and to completely inform the scope of the present disclosure to those of ordinary skill in the technical field to which the present disclosure belongs, and the present disclosure is only defined by the scope of the claims.

For simplicity and clarity of illustration, elements in the drawings are not necessarily drawn to scale. The same reference numbers in different drawings represent the same or similar elements, and as such perform similar functionality. Further, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure can be practiced without these specific details. In other instances, well-known methods, procedures, components, and circuits have not been described in detail so as not to unnecessarily obscure aspects of the present disclosure. Examples of various embodiments are illustrated and described further below. It will be understood that the description herein is not intended to limit the claims to the specific embodiments described. On the contrary, it is intended to cover alternatives, modifications, and equivalents as can be included within the spirit and scope of the present disclosure as defined by the appended claims.

A shape, a size, a ratio, an angle, a number, etc. disclosed in the drawings for illustrating embodiments of the present disclosure are illustrative, and the present disclosure is not limited thereto.

The terminology used herein is directed to the purpose of describing particular embodiments only and is not intended to be limiting of the present disclosure. As used herein, the singular constitutes “a” and “an” are intended to include the plural constitutes as well, unless the context clearly indicates otherwise. It will be further understood that the terms “comprise”, “comprising”, “include”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of associated listed items. Expression such as “at least one of” when preceding a list of elements can modify the entire list of elements and may not modify the individual elements of the list. In interpretation of numerical values, an error or tolerance therein can occur even when there is no explicit description thereof.

In addition, it will also be understood that when a first element or layer is referred to as being present “on” a second element or layer, the first element can be disposed directly on the second element or can be disposed indirectly on the second element with a third element or layer being disposed between the first and second elements or layers. It will be understood that when an element or layer is referred to as being “connected to”, or “connected to” another element or layer, it can be directly on, connected to, or connected to the other element or layer, or one or more intervening elements or layers can be present. In addition, it will also be understood that when an element or layer is referred to as being “between” two elements or layers, it can be the only element or layer between the two elements or layers, or one or more intervening elements or layers can also be present.

Further, as used herein, when a layer, film, region, plate, or the like is disposed “on” or “on a top” of another layer, film, region, plate, or the like, the former can directly contact the latter or still another layer, film, region, plate, or the like can be disposed between the former and the latter. As used herein, when a layer, film, region, plate, or the like is directly disposed “on” or “on a top” of another layer, film, region, plate, or the like, the former directly contacts the latter and still another layer, film, region, plate, or the like is not disposed between the former and the latter. Further, as used herein, when a layer, film, region, plate, or the like is disposed “below” or “under” another layer, film, region, plate, or the like, the former can directly contact the latter or still another layer, film, region, plate, or the like can be disposed between the former and the latter. As used herein, when a layer, film, region, plate, or the like is directly disposed “below” or “under” another layer, film, region, plate, or the like, the former directly contacts the latter and still another layer, film, region, plate, or the like is not disposed between the former and the latter.

In descriptions of temporal relationships, for example, temporal precedent relationships between two events such as “after”, “subsequent to”, “before”, etc., another event can occur therebetween unless “directly after”, “directly subsequent” or “directly before” is not indicated.

When a certain embodiment can be implemented differently, a function or an operation specified in a specific block can occur in a different order from an order specified in a flowchart. For example, two blocks in succession can be actually performed substantially concurrently, or the two blocks can be performed in a reverse order depending on a function or operation involved.

It will be understood that, although the terms “first”, “second”, “third”, and so on can be used herein to describe various elements, components, regions, layers and/or periods, these elements, components, regions, layers and/or periods should not be limited by these terms. These terms are used to distinguish one element, component, region, layer or section from another element, component, region, layer or period. Thus, a first element, component, region, layer or section as described under could be termed a second element, component, region, layer or period, without departing from the spirit and scope of the present disclosure.

The features of the various embodiments of the present disclosure can be partially or entirely combined with each other, and can be technically associated with each other or operate with each other. The embodiments can be implemented independently of each other and can be implemented together in an association relationship.

In interpreting a numerical value, the value is interpreted as including an error range unless there is no separate explicit description thereof.

It will be understood that when an element or layer is referred to as being “connected to”, or “connected to” another element or layer, it can be directly on, connected to, or connected to the other element or layer, or one or more intervening elements or layers can be present. In addition, it will also be understood that when an element or layer is referred to as being “between” two elements or layers, it can be the only element or layer between the two elements or layers, or one or more intervening elements or layers can also be present.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, “embodiments,” “examples,” “aspects, and the like should not be construed such that any aspect or design as described is superior to or advantageous over other aspects or designs.

Further, the term ‘or’ means ‘inclusive or’ rather than ‘exclusive or’. That is, unless otherwise stated or clear from the context, the expression that ‘x uses a or b’ means any one of natural inclusive permutations. Furthermore, the term “can” encompasses all the meanings and coverages of the term “may.” The term “disclosure” is interchangeably used with, or encompasses all the meanings and coverages of, the term “invention.”

The terms used in the description below have been selected as being general and universal in the related technical field. However, there can be other terms than the terms depending on the development and/or change of technology, convention, preference of technicians, etc. Therefore, the terms used in the description below should not be understood as limiting technical ideas, but should be understood as examples of the terms for illustrating embodiments.

Further, in a specific case, a term can be arbitrarily selected by the applicant, and in this case, the detailed meaning thereof will be described in a corresponding description period. Therefore, the terms used in the description below should be understood based on not simply the name of the terms, but the meaning of the terms and the contents throughout the Detailed Descriptions.

In description of flow of a signal, for example, when a signal is delivered from a node A to a node B, this can include a case where the signal is transferred from the node A to the node B via another node unless a phrase ‘immediately transferred’ or ‘directly transferred’ is used.

Hereinafter, a display device according to some embodiments and a method for compensating for degradation thereof will be described. All the components of each display device according to all embodiments of the present disclosure are operatively coupled and configured.

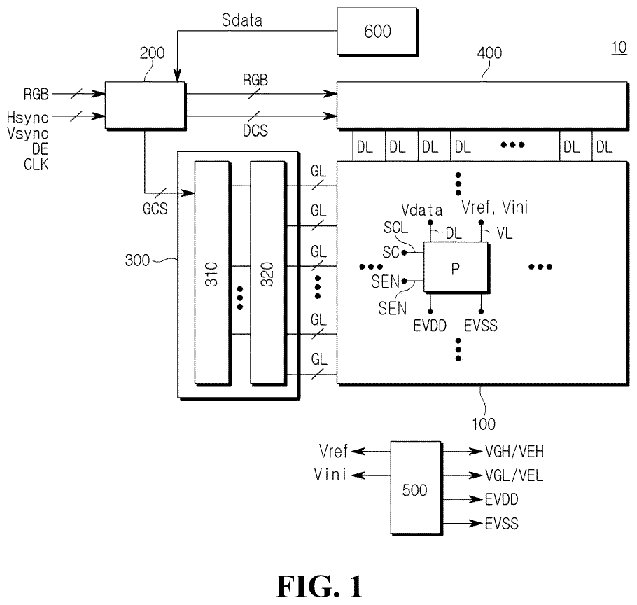

FIG. 1 is a block diagram schematically showing a display device according to an embodiment of the present disclosure.

Referring to FIG. 1, a display device 10 includes a display panel 100 including a plurality of pixels P, a controller 200, and a gate driver 300 that is configured to supply a gate signal to each of the plurality of pixels P, a data driver 400 that is configured to supply a data signal to each of the plurality of pixels P, and a power supply 500 that is configured to supply power required for operation to each of the plurality of pixels P.

In the display panel 100, a plurality of gate lines GL and a plurality of data lines DL intersect each other, and each of the plurality of pixels P are connected to the gate line GL and the data line DL. Specifically, one pixel P receives the gate signal from the gate driver 300 via one of the gate lines GL, receives the data signal from the data driver 400 via one of the data lines DL, and receives a high potential driving voltage EVDD and a low potential driving voltage EVSS from the power supply 500 via a power supply line.

The gate line GL is configured to supply a scan signal SC and a sensing signal SEN to the pixel and the data line DL is configured to supply a data voltage Vdata to the pixel. Furthermore, according to various embodiments, the gate line GL can include a plurality of scan lines SCL that are configured to supply the scan signal SC and a sensing signal line SENL that supplies the sensing signal SEN. Furthermore, the plurality of pixels P can additionally include at least one power line VL and can receive an initialization voltage Vini, and a reference voltage Vref via the power line VL.

Furthermore, each pixel P includes a light-emitting element and a pixel circuit that is configured to control an operation of the light-emitting element. The pixel circuit includes a plurality of switching elements, a driving element, and a capacitor. In this regard, each of the switching elements and the driving element can be embodied as a thin-film transistor (TFT). In the pixel circuit, the driving element controls an amount of current supplied to the light-emitting element based on the data voltage to adjust an amount of light emitted from the light-emitting element. Furthermore, the plurality of switching elements receive the scan signal SC supplied via the plurality of scan lines SCL and the sensing signal SEN supplied via the sensing signal line SENL and operate the pixel circuit based on the scan signal SC and the sensing signal SEN.

The display panel 100 can be embodied as a non-transmissive display panel or a transmissive display panel. The transmissive display panel can be applied to a transparent display device where an image is displayed on a screen and a real object in a background is visible to a viewer viewing a front of the display device. The display panel 100 can be manufactured as a flexible display panel. In addition, the flexible display panel can be embodied as an OLED panel using a plastic substrate, but is not limited thereto.

The pixels P can include a red pixel, a green pixel, and a blue pixel to emit light of corresponding colors. The pixels P can further include a white pixel. Each of the pixels P includes a pixel circuit. However, in another embodiment, pixels P of other colors can be used.

Touch sensors can be disposed on the display panel 100. Touch input can be sensed using separate touch sensors or can be sensed through the pixels P. The touch sensors can be disposed on the screen of the display panel in an on-cell type or add-on type or can be embodied as in-cell type touch sensors built into the display panel 100. The touch sensors can be configured so that a viewer's touch on the display panel 100 is detected by the display panel 100.

Additionally, the controller 200 processes image data RGB input from an external source such as a host system so as to be adapted to a size and a resolution of the display panel 100 and supplies the processed image data to the data driver 400. The controller 200 generate a gate control signal GCS and a data control signal DCS based on synchronization signals, for example, a clock signal CLK, a data enable signal DE, a horizontal synchronization signal Hsync, and a vertical synchronization signal Vsync input from the external source. The controller 200 is further configured to supply the generated gate control signal GCS and data control signal DCS to the gate driver 300 and the data driver 400, respectively, thereby controlling the gate driver 300 and the data driver 400.

The controller 200 can be configured to be coupled to various processors. For example, the controller 200 can be coupled to a microprocessor, a mobile processor, an application processor, etc., depending on a type of a device on which the controller is mounted.

The host system can be any one of a television (TV) system, a set top box, a navigation system, a personal computer (PC), a home theater system, a mobile device, a wearable device, and a vehicle system, but is not limited thereto.

The controller 200 generates, based on the timing signals Vsync, Hsync, and DE received from the host system, the gate control signal GSC for controlling the operation timing of the gate driver 300, and the data control signal DSC for controlling the operation timing of the data driver 400. The controller 200 controls the operation timings of the gate driver 300 and the data driver 400 to synchronize the gate driver 300 and the data driver 400 with each other.

A level shifter converts a voltage level of the gate control signal GSC output from the controller 200 into a gate on voltage VGL and VEL and a gate off voltage VGH and VEH which in turn are supplied to the gate driver 300. The level shifter converts a low-level voltage of the gate control signal GSC to a gate low voltage VGL, and converts a high-level voltage of the gate control signal GSC to a gate high voltage VGH. Additionally, the gate control signal GSC includes a start pulse and a shift clock.

The gate driver 300 is configured to supply the scan signal SC to the gate line GL according to the gate control signal GCS supplied from the controller 200. The gate driver 300 can be disposed at one side or each of both opposing sides of the display panel 100 and in a GIP (Gate In Panel) manner.

The gate driver 300 sequentially outputs the gate signal to the plurality of gate lines GL under control of the controller 200. The gate driver 300 can shift the gate signal using a shift register and sequentially supply the shifted gate signal to the gate lines GL.

The gate signal output by the gate driver 300 can include the scan signal SC and the sensing signal SEN in an organic light-emitting display device. The scan signal SC includes a scan pulse swinging between the gate on voltage VGL and the gate off voltage VGH. The sensing signal can include a sensing signal pulse that swings between the gate on voltage VEL and the gate off voltage VEH.

The scan pulse is synchronized with the data voltage Vdata to select pixels of a line to which data is to be written. The sensing signal SEN defines pixels P of a line from which a driving current is to be sensed.

The gate driver 300 can include a sensing signal driver 310 and at least one scan driver 320. The sensing signal driver 310 is configured to output the sensing signal pulse in response to the start pulse and the shift clock received from the controller 200 and sequentially shifts the sensing signal pulse according to the shift clock. Specifically, the sensing signal driver 310 receives the gate control signal GCS transmitted by the controller 200, and based on the gate control signal GCS, the sensing signal driver 310 outputs the sensing signal pulse in response to the start pulse and the shift clock transmitted in the gate control signal GCS. In addition, each of the at least one scan driver 320 is configured to output the scan pulse in response to the start pulse and the shift clock received from the controller 200 in the gate control signal GCS, and shift the scan pulse according to a shift clock timing.

The data driver 400 is configured to convert the image data RGB into the data voltage Vdata according to the data control signal DCS supplied from the controller 200, and is configured to supply the converted data voltage Vdata to the pixels P via the data lines DL.

Additionally, the data driver 400 can supply a reference data voltage to the pixel P via the data line DL in a sensing mode.

Referring to FIG. 1, it is illustrated that one data driver 400 is disposed at one side of the display panel 100. However, a number and a position of the data drivers 200 are not limited thereto. That is, the data driver 400 can be embodied as a plurality of integrated circuits (ICs) which can be disposed at one side of the display panel 100 and can be separately arranged along the one side. In addition, in another embodiment, numerous data drivers 200 can be arranged along numerous sides of the display panel 100.

Next, the power supply 500 is configured to generate direct current (DC) power necessary for operating a pixel array of the display panel 100 and the display panel driver using a DC-DC converter. The DC-DC converter can include a charge pump, a regulator, a buck converter, a boost converter, etc., but is not limited thereto. The power supply 500 receives a DC input voltage applied from the host system and generates DC voltages such as the gate on voltage VGL and VEL, the gate off voltage VGH and VEH, the high-potential driving voltage EVDD, the low-potential driving voltage EVSS, etc. The gate on voltage VGL and VEL and the gate off voltage VGH and VEH are supplied to the level shifter and the gate driver 300. Each of the high-potential driving voltage EVDD and the low-potential driving voltage EVSS is commonly supplied to the pixels P.

Furthermore, the power supply 500 can generate direct current voltages such as the initialization voltage Vini and the reference voltage Vref. The initialization voltage Vini and the reference voltage Vref are supplied to the pixels P via the at least one power line VL. In this regard, the at least one power line VL can include an initialization voltage bus line ViniL and a reference voltage bus line VrefL. In one example, the initialization voltage bus line ViniL and the reference voltage bus line VrefL can be disposed between the gate driver 300 and the display area AA. However, embodiments of the present disclosure are not limited thereto.

In addition, a current sensor 600 is configured to sense the driving current on a block basis of the display panel 100, convert the second driving current into sensing data Sdata as a digital signal, and provide the sensing data Sdata to the controller 200.

The controller 200 can calculate a compensation factor representing the degradation characteristics of the display panel 100 based on the sensing data Sdata and compensate for the image data based on the calculated compensation factor, thereby improving image quality of an image displayed by the display panel 100.

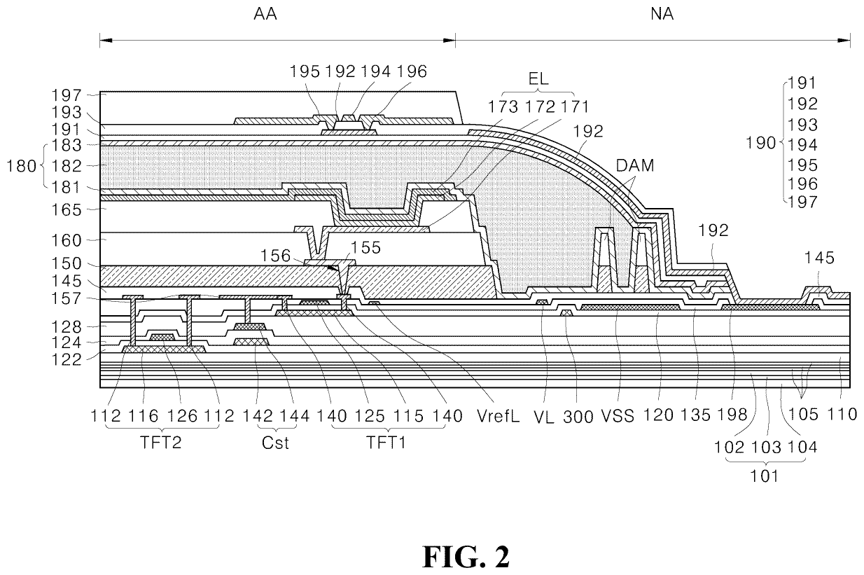

Next, FIG. 2 is a cross-sectional view showing a stack structure of a display device according to an embodiment of the present disclosure.

Referring to FIG. 2, the display panel 100 includes a display area AA where the pixel P is located, and a non-display area NA surrounding the display area AA. The gate driver 300 and the data driver 400 can be disposed in the non-display area NA.

The display panel 100 according to an embodiment of the present disclosure includes a substrate 101, a first thin-film transistor TFT1, a second thin-film transistor TFT2, a bank layer 165, a light-emitting element EL, an encapsulation layer 180, a touch layer 190, a touch protective film 197, a dam DAM, and a pad 198.

The first thin-film transistor TFT1 can be disposed on the substrate 101. The thin-film transistor TFT1 is configured to drive the light-emitting element EL of the display area AA.

The substrate 101 supports various components of the display panel 100. The substrate 101 can be made of a transparent insulating material, such as glass or plastic, but is not limited thereto. When the substrate 101 is made of plastic, the substrate can be referred to as a plastic film or plastic substrate. For example, the substrate 101 can be in a form of a film including one of polyimide-based polymer, polyester-based polymer, silicone-based polymer, acryl-based polymer, polyolefin-based polymer, and copolymer thereof. However, embodiments of the present disclosure are not limited thereto.

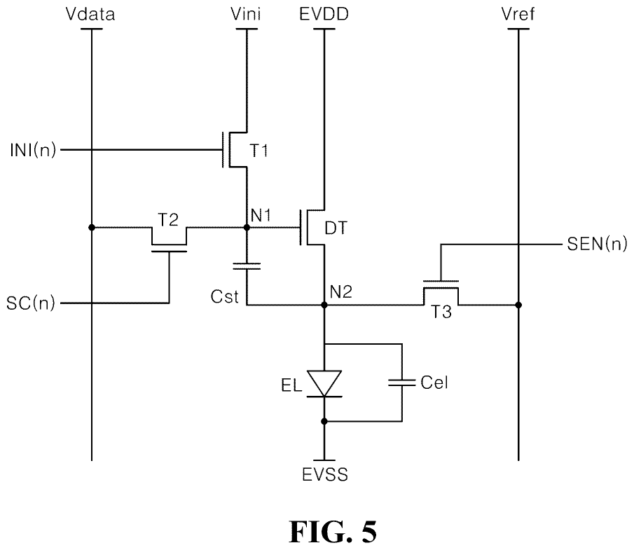

The first thin-film transistor TFT1 can include a semiconductor layer 115, a gate electrode 125, and source and drain electrodes 140. The first thin-film transistor TFT1 is a driving transistor (T1 in FIG. 5). The semiconductor layer 115 can be made of polysilicon (p-Si). In this case, a predetermined area thereof can be doped with impurities. Furthermore, in another embodiment, the semiconductor layer 115 can be made of amorphous silicon a-Si or various organic semiconductor materials such as pentacene. In addition, the semiconductor layer 115 can be made of oxide. Embodiments of the present disclosure are not limited to the material constituting the semiconductor layer 115. The semiconductor layer 115 can be an active layer. However, embodiments of the present disclosure are not limited thereto.

The gate electrode 125 can be disposed on top of the semiconductor layer 115. The gate electrode 125 can be made of a variety of conductive materials, such as magnesium (Mg), aluminum (Al), nickel (Ni), chromium (Cr), molybdenum (Mo), tungsten (W), gold (Au) or an alloy thereof, etc. However, embodiments of the present disclosure are not limited thereto. In one embodiment, the gate electrode 125 can be disposed over a central portion of the semiconductor layer 115. In addition, a length of the gate electrode 125 can be smaller than a length of the semiconductor layer 115.

A gate insulating layer can be disposed between the semiconductor layer 115 and the gate electrode 125. The gate insulating layer can be a layer configured to insulate the semiconductor layer 115 and the gate electrode 125 from each other, and can be made of an insulating material. For example, the gate insulating layer can include a single or double layer made of silicon oxide (SiOx) or silicon nitride (SiNx). However, embodiments of the present disclosure are not limited thereto.

The source and drain electrodes 140 can be electrically connected to the semiconductor layer 115 and spaced apart from each other. The source and drain electrodes 140 can be disposed on the insulating layer. Each of the source and drain electrodes 140 can be made of a conductive material, for example, copper (Cu), aluminum (Al), molybdenum (Mo), titanium (Ti) or an alloy thereof, etc. However, embodiments of the present disclosure are not limited thereto. In addition, a lower portion of the source and drain electrodes 140 can be disposed lower than a lower surface of the gate electrode 125. Further, an upper portion of the source and drain electrodes 140 can be disposed higher than an upper surface of the gate electrode 125.

Next, the capacitor Cst can be disposed on the substrate 101. The capacitor Cst can include a first gate electrode 142 and a second gate electrode 144. A second gate insulating layer 124 can be disposed between the first gate electrode 142 and the second gate electrode 144. At least one of the first gate electrode 142 and the second gate electrode 144 can be connected to the electrode of the thin-film transistor TFT1. The capacitor Cst can be connected to the thin-film transistor TFT1 via a connection electrode 157. In addition, the second gate electrode 142 can be disposed on a first gate insulating layer 122. Further, the second gate insulating layer 124 can be disposed on an upper surface of the second gate electrode 142. Additionally, the second gate insulating layer 124 can protrude upwards above the second gate electrode 142.

A second thin-film transistor TFT2 can be disposed on the substrate 101. The second thin-film transistor TFT2 can include a semiconductor layer 116, a gate electrode 126, and source and drain electrodes 112. The second thin-film transistor TFT2 can be one of first to seventh transistors T1 to T7. The first gate insulating layer 122 can be disposed between the semiconductor layer 116 and the gate electrode 126. In addition, a lower portion of the source and drain electrodes 112 can be disposed lower than a lower surface of the gate electrode 126. Further, an upper portion of the source and drain electrodes 112 can be disposed higher than an upper surface of the gate electrode 126.

An interlayer insulating layer 128 can be disposed between the first thin-film transistor TFT1 and the capacitor Cst, or between the first thin-film transistor TFT1 and the second thin-film transistor TFT2. In addition, the first thin-film transistor TFT1 can be disposed closer to an edge portion of the display area AA.

For convenience of illustration, among the various thin-film transistors that can be included in the display device 10, only the first and second thin-film transistors TFT1 and TFT2 are shown. However, a plurality of thin-film transistors can be included in the display panel 100. Further, an example in which the thin-film transistor has a coplanar structure is described. However, the thin-film transistor can be implemented to have other structures such as a staggered structure. The present disclosure is not limited thereto.

The first thin-film transistor TFT1 can receive the high-potential driving voltage EVDD in response to the data voltage Vdata supplied to the gate electrode 125 of the first thin-film transistor TFT1. Based on the received high-potential driving voltage EVDD, the first thin-film transistor TFT1 is configured to control the current amount supplied to the light-emitting element EL to adjust an amount of light emitted from the light-emitting element EL. The first thin-film transistor TFT1 can supply a constant current based on a voltage charged in the capacitor Cst to maintain light emission of the light-emitting element EL until the data voltage Vdata of a next frame is supplied thereto. The high-potential supply line can extend in a parallel manner to the data line. Accordingly, consistency of an image displayed by the display panel 100 can be improved.

Referring to FIG. 2, the first thin-film transistor TFT1 includes the semiconductor layer 115 disposed on the interlayer insulating layer 128, the gate electrode 125 overlapping the semiconductor layer 115 while a second insulating layer 120 is interposed therebetween, and the source and drain electrodes 140 formed on a third insulating layer 135 and contacting the semiconductor layer 115.

The semiconductor layer 115 can act as an area where a channel is formed during an operation of the first thin-film transistor TFT1. The semiconductor layer 115 can be made of an oxide semiconductor, or can be made of various organic semiconductors such as amorphous silicon (a-Si), polycrystalline silicon (poly-Si), or pentacene. However, the present disclosure is not limited thereto. The semiconductor layer 115 can be formed on the interlayer insulating layer 128. The semiconductor layer 115 can include a channel area, a source area, and a drain area. The channel area can overlap with the gate electrode 125 while the second insulating layer 120 is interposed therebetween. The channel area can be formed between the source and drain electrodes 140. The source area can be electrically connected to the source electrode 140 via a contact hole extending through the second insulating layer 120 and the third insulating layer 135. The drain area can be electrically connected to the drain electrode 140 via a contact hole extending through the second insulating layer 120 and the third insulating layer 135. In an embodiment, the gate electrode 125 is configured to correspond with the third insulating layer 135.

A buffer layer 105 and a first insulating layer 110 can be disposed between a semiconductor layer 116 and the substrate 101. The buffer layer 105 can delay diffusion of moisture and/or oxygen invading into the substrate 101. The first insulating layer 110 can protect the semiconductor layer 115 and can block various types of defects introduced from the substrate 101. Further, because the first insulating layer 110 is configured to protect the semiconductor layer 115 and block various types of defects, the first insulating layer 110 can be disposed on the buffer layer 105. In addition, the buffer layer 105 can be disposed on the substrate 101.

In addition, the uppermost layer of the buffer layer 105 can be in contact with the first insulating layer 110. Further, the uppermost layer of the buffer layer 105 can be made of a material having different etching characteristics from those of each of the remaining layers of the buffer layer 105, the first insulating layer 110, the second insulating layer 120 and the third insulating layer 135. The uppermost layer of the buffer layer 105 contacting the first insulating layer 110 can be made of one of silicon nitride (SiNₓ) and silicon oxide (SiOₓ), but is not limited thereto. Each of the remaining layers of the buffer layer 105, the first insulating layer 110, the second insulating layer 120, and the third insulating layer 135 can be made of the other of silicon nitride (SiNₓ) and silicon oxide (SiOₓ), but is not limited thereto. For example, the uppermost layer of the buffer layer 105 in contact with the first insulating layer 110 can be made of silicon nitride (SiNₓ), while each of the remaining layers of the buffer layer 105, the first insulating layer 110, the second insulating layer 120, and the third insulating layer 135 can be made of silicon oxide (SiOₓ). The present disclosure is not limited thereto.

The gate electrode 125 can be formed on the second insulating layer 120 and can overlap the channel area of the semiconductor layer 115 while the second insulating layer 120 is interposed therebetween. The gate electrode 125 can be made of a first conductive material and can be embodied as a single layer or multi-layers made of magnesium (Mg), molybdenum (Mo), aluminum (Al), chromium (Cr), gold (Au), titanium (Ti), nickel (Ni), neodymium (Nd), copper (Cu), or an alloy thereof. The present disclosure is not limited thereto.

The source electrode 140 can be connected to the exposed source area of the semiconductor layer 115 via the contact hole extending through the second insulating layer 120 and the third insulating layer 135. The drain electrode 140 can be opposite to the source electrode 140 and can be connected to the drain area of the semiconductor layer 115 via the contact hole extending through the second insulating layer 120 and the third insulating layer 135. In addition, the gate electrode 125 can be disposed in between the source electrode 140 and the drain electrode 140. Each of the source and drain electrodes 140 can be made of a second conductive material and can be embodied as a single layer or multi-layers made of molybdenum (Mo), aluminum (Al), chromium (Cr), gold (Au), titanium (Ti), nickel (Ni), neodymium (Nd), copper (Cu), or an alloy thereof. The present disclosure is not limited thereto.

A connection electrode 155 can be disposed between a first middle layer 150 and a second middle layer 160. The connection electrode 155 can be connected to the drain electrode 140 via a connection electrode contact hole 156 extending through a protective film 145 and the first middle layer 150. The connection electrode 155 can be made of a material having low resistivity and identical to or similar to that of the drain electrode 140. The present disclosure is not limited thereto. In addition, upper surfaces of the source and drain electrode 140 can be exposed to the protective film 145. A reference voltage line VrefL can be a sub-power line branched from the reference voltage bus line of the power line VL, and can be disposed in the same layer as a layer of the source and drain electrodes 140 of the thin-film transistor TFT2. Embodiments of the present disclosure are not limited thereto, and the reference voltage line VrefL can be disposed on the interlayer insulating layer 128 or the second insulating layer 120. In another embodiment, the reference voltage line VrefL can be disposed in the protective film 145.

Next, the light-emitting element EL including a light-emitting layer 172 can be disposed on a second middle layer 160 and a bank layer 165. The light-emitting element 170 can include an anode electrode 171, at least one light-emitting layer 172 formed on the anode electrode 171, and a cathode electrode 173 formed on the at least one light-emitting layer 172.

The anode electrode 171 can be electrically connected to an exposed portion of the connection electrode 155 disposed on the first middle layer 150 and facing the second middle layer 160 via a contact hole extending through the second middle layer 160.

The anode electrode 171 of each pixel is not covered with the bank layer 165. The bank layer 165 can be made of an opaque material (e.g., black) to prevent light interference between adjacent pixels. In this case, the bank layer 165 can include a light-shielding material including at least one of color pigment, organic black, and carbon black. However, the present disclosure is not limited thereto.

The at least one light-emitting layer 172 can be formed on a portion of the anode electrode 171 corresponding to a light-emitting area defined by an open portion of the bank layer 165. The at least one light-emitting layer 172 can include a hole transport layer, a hole injection layer, a hole blocking layer, a light-emitting layer 172, an electron injection layer, an electron blocking layer, and an electron transport layer on the anode electrode 171. A stacking order of the hole transport layer, the hole injection layer, the hole blocking layer, the light-emitting layer 172, the electron injection layer, the electron blocking layer, and the electron transport layer can be based on a light-emitting direction. In addition, the at least one light-emitting layer 172 can include first and second light-emitting stacks facing each other while a charge generating layer is interposed therebetween. In this case, the at least one light-emitting layer 172 of one of the first and second light-emitting stacks can generate blue light, while the at least one light-emitting layer 172 of the other of the first and second light-emitting stacks can generate yellow-green light, so that white light can be generated from a combination of the first and second light-emitting stacks. The white light generated from the combination of the first and second light-emitting stacks can be incident on a color filter positioned above or below the at least one light-emitting layer 172, such that a color image can be realized. In another example, each light-emitting layer 172 can generate each color light corresponding to each pixel without a separate color filter such that a color image can be rendered. For example, the light-emitting layer 172 of a red (R) pixel emits red light, the light-emitting layer 172 of a green (G) pixel emits green light, and the light-emitting layer 172 of a blue (B) pixel emits blue light. However, in another embodiment, the at least one light-emitting layer 172 can be configured to emit any color. For example, the light-emitting layer 172 can be configured to include a, a white pixel that emits a white light, a cyan pixel that emits a cyan light, a yellow pixel that emits a yellow light, any other color specific pixel that displays a color used by the display device 10.

The cathode electrode 173 can be formed to face the anode electrode 171 while the at least one light-emitting layer 172 is disposed therebetween, and can receive the high-potential driving voltage EVDD.

The anode electrode 171 can be disposed along second middle layer 160. In addition, the at least one light-emitting layer 172 can be disposed downwards to contact with an upper surface of the anode electrode 171 in a “U” shape. Further, the cathode electrode 173 can be disposed on the at least one light-emitting layer 172. Accordingly, the cathode electrode 173 can disposed inside of the “U” shape, and is therefore configured to have a smaller extension length in the “U” shape than an extension length of the at least one light-emitting layer 172.

In another embodiment, the second thin-film transistor TFT2 can be connected to the connection electrode 155. The connection electrode 155 can be disposed between a first middle layer 150 and a second middle layer 160. The connection electrode 155 can be connected to the drain electrode 112 via a connection electrode contact hole 156 extending through a protective film 145 and the first middle layer 150. The connection electrode 155 can be made of a material having low resistivity and identical to or similar to that of the drain electrode 112. The present disclosure is not limited thereto. In addition, upper surfaces of the source and drain electrode 112 can be exposed to the protective film 145.

Further, the connection electrode 155 connected to the second thin-film transistor TFT2 can be disposed on the anode electrode 171. The anode electrode 171 can be electrically connected to an exposed portion of the connection electrode 155 disposed on the first middle layer 150 and facing the second middle layer 160 via a contact hole extending through the second middle layer 160. In addition, the anode electrode 171 can be disposed on a lower surface of the at least one light-emitting layer 172. Additionally, the at least one light-emitting layer 172 can be disposed on a lower surface of the cathode electrode 173. However, the current configuration is not limited thereto.

Next, an encapsulation layer 180 can block penetration of external moisture, oxygen, or other foreign substances into the light-emitting element EL, which is vulnerable to external moisture or oxygen. To this end, the encapsulation layer 180 can include at least one inorganic encapsulation layer and at least one organic encapsulation layer. However, the present disclosure is not limited thereto. In the present disclosure, a structure of the encapsulation layer 180 in which a first encapsulation layer 181, a second encapsulation layer 182, and a third encapsulation layer 183 are sequentially stacked is described by way of example.

The first encapsulation layer 181 can be formed on the substrate 101 on which the cathode electrode 173 has been formed. The third encapsulation layer 183 is formed on the substrate 101 on which the second encapsulation layer 182 has been formed. The third encapsulation layer 183 and the first encapsulation layer 181 can surround a top face, a bottom face and a side face of the second encapsulation layer 182. The first encapsulation layer 181 and the third encapsulation layer 183 can minimize or prevent penetration of external moisture, oxygen, or foreign substances into the light-emitting element EL. Each of the first encapsulation layer 181 and the third encapsulation layer 183 can be made of an inorganic insulating material that can be deposited at a low temperature, such as silicon nitride (SiNₓ), silicon oxide (SiOₓ), silicon oxynitride (SiON), or aluminum oxide (Al₂O₃). Each of the first encapsulation layer 181 and the third encapsulation layer 183 is deposited in a low temperature atmosphere. Thus, during a deposition process of the first encapsulation layer 181 and the third encapsulation layer 183, the light-emitting element EL which is vulnerable to a high-temperature atmosphere can be prevented from being damaged. The first, second, and third encapsulation layers 181, 182, and 103 can be disposed through both the display area AA and the non-display area NA.

The second encapsulation layer 182 serves as a shock-absorbing layer configured to relieve a stress between layers due to bending of the display device 10, and can planarize a step between layers. The second encapsulation layer 182 can be made of a non-photosensitive organic insulating material such as acryl resin, epoxy resin, phenolic resin, polyamide resin, polyimide resin, polyethylene or silicon oxycarbon (SiOC) or a photosensitive organic insulating material such as photoacryl. However, the present disclosure is not limited thereto. When the second encapsulation layer 182 is formed using an inkjet method, a dam DAM can be disposed to prevent the second encapsulation layer 182 in a liquid state from spreading to an edge of the substrate 101. The dam DAM can be closer to the edge of the substrate 101 than the second encapsulation layer 182 can be. The dam DAM can prevent the second encapsulation layer 182 in the liquid state from spreading to a pad area where a conductive pad disposed at the outermost side of the substrate 101 is disposed.

The dam DAM is designed to prevent diffusion of the second encapsulation layer 182. However, when the second encapsulation layer 182 overflows the dam DAM during a process, the second encapsulation layer 182 as an organic layer can be exposed to an outside, so that moisture or the like can invade the light-emitting element. Therefore, to prevent the invasion, at least ten dams DAM can be stacked, thereby preventing the second encapsulation layer 182 from overflowing.

The dam DAM can be disposed on the interlayer insulating layer disposed on the third insulating layer 135 and in the non-display area NA. However, embodiments of the present disclosure are not limited thereto, and the interlayer insulating layer can be the third insulating layer 135.

Further, the dam DAM, and the first middle layer 150 and the second middle layer 160 can be formed simultaneously. The first middle layer 150, and a lower layer of the dam DAM can be formed simultaneously. The second middle layer 160, and an upper layer of the dam DAM can be formed simultaneously. Thus, the dam DAM can have a double layer structure.

Accordingly, the dam DAM can be made of the same material as that of each of the first middle layer 150 and the second middle layer 160. However, embodiments of the present disclosure are not limited thereto.

The dam DAM can overlap the low-potential driving power line VSS. For example, the low-potential driving power line VSS can be formed in a layer under the dam DAM and in the non-display area NA.

In addition, the dam DAM can be encapsulated by the first encapsulation layer 181. Accordingly, the second encapsulation layer 182 can be prevented from exposing the light-emitting element to excess moisture.

Next, the low-potential driving power line VSS and a gate driver 300 in a form of a gate in panel (GIP) can surround a periphery of the display panel 100. The low-potential driving power line VSS can be located outwardly of the gate driver 300. Further, the low-potential driving power line VSS can be connected to the anode electrode 171 to apply a common voltage thereto. The gate driver 300 is simply illustrated in plan and cross-sectional views. However, the gate driver 300 can be configured using a thin-film transistor TFT having the same structure as that of the thin-film transistor TFT of the display area AA.

The low-potential driving power line VSS is disposed outwardly of the gate driver 300. The low-potential driving power line VSS is disposed outwardly of the gate driver 300 and surrounds the display area AA. The low-potential driving power line VSS can be made of the same material as that of each of the source and drain electrodes 140 of the thin-film transistor TFT. The present disclosure is not limited thereto. For example, the low-potential driving power line VSS can be made of the same material as that of the gate electrode 125.

Further, the low-potential driving power line VSS can be electrically connected to the anode electrode 171. The low-potential driving power line VSS can supply the low-potential driving voltage EVSS to the plurality of pixels in the display area AA.

The low-potential driving power line VSS can be disposed on the third insulating layer 135. Alternatively, the low-potential driving power line VSS can be disposed on a layer of the source and drain electrodes 140 or the gate electrode 125 of the first thin-film transistor TFT1. However, embodiments of the present disclosure are not limited thereto.

The at least one power line VL can be disposed between the gate driver 300 and the display area AA. The at least one power line VL can be disposed in the same layer as a layer of the source and drain electrodes 140 of the first thin-film transistor TFT1. However, embodiments of the present disclosure are not limited thereto. The at least one power line VL is shown in a simple manner in the cross-sectional view. However, the initialization voltage bus line ViniL and the reference voltage bus line VrefL can be arranged side by side and can be disposed in the same layer. Alternatively, the initialization voltage bus line ViniL and the reference voltage bus line VrefL can be disposed in different layers in an overlapping or non-overlapping manner. The initialization voltage bus line can supply the initialization voltage Vini to the plurality of pixels in the display area AA. The reference voltage bus line VrefL can supply the reference voltage Vref to the plurality of pixels in the display area AA. The at least one power line VL is illustrated as being disposed between gate driver 300 and the display area AA. However, embodiments of the present disclosure are not limited thereto.

A touch layer 190 can be disposed on the encapsulation layer 180. In the touch layer 190, a touch buffer film 191 can be positioned between a touch sensor metal including touch electrode connection lines 192 and 194 and touch electrodes 195 and 196 and the cathode electrode 173 of the light-emitting element EL.

The touch buffer film 191 can prevent chemical (developer, etchant, etc.) used in a manufacturing process of the touch sensor metal disposed on the touch buffer film 191 or moisture from the outside from reaching the at least one light-emitting layer 172 including an organic material. Accordingly, the touch buffer layer 191 can prevent damage to the at least one light-emitting layer 172, as the at least one light-emitting layer 172 is vulnerable to chemicals, or moisture.

The touch buffer film 191 can be made of an organic insulating material that can be formed at a low temperature below or equal to a certain temperature (approximately 100 degrees Celsius) to prevent damage to the at least one light-emitting layer 172 including the organic material vulnerable to a high temperature, and that has a low dielectric constant of 1 to 3. For example, the touch buffer layer 191 can be made of an acryl-based, epoxy-based, or siloxane-based material, but is not limited thereto. The touch buffer film 191 made of the organic insulating material and having planarization performance can prevent damage to the encapsulation layer 180 and fracture of the touch sensor metal formed on the touch buffer film 191 due to bending of the organic light-emitting display device.

According to a mutual-capacitance-based touch sensor structure, the touch electrodes 195 and 196 can be disposed on the touch buffer layer 191, and the touch electrodes 195 and 196 can be disposed to intersect each other.

The touch electrode connection lines 192 and 194 can electrically connect the touch electrodes 195 and 196 to each other. The touch electrode connection lines 192 and 194 and the touch electrodes 195 and 196 can be positioned on different layers while the touch insulating film 193 is interposed therebetween. Further, the touch electrode connection lines 192 and 194 can be disposed in both the display area AA and the non-display area NA.

In addition, the touch electrode connection lines 192 and 194 can overlap the bank layer 165, thereby preventing an aperture ratio from being lowered.

In one example, a portion of the touch electrode connection line 192 can extend along upper and side surfaces of the encapsulation layer 180 and upper and side surfaces of the dam DAM and then can be electrically connected to a touch driver circuit via a pad 198. Thus, the touch electrodes 195 and 196 can be electrically connected to the touch driver circuit.

The portion of the touch electrode connection line 192 can receive a touch driving signal from the touch driver circuit and transmit the touch driving signal to the touch electrodes 195 and 196, and can receive a touch sensing signal from the touch electrodes 195 and 196 and can transmit the same to the touch driver circuit.

A touch protective film 197 can be disposed on the touch electrodes 195 and 196 and the touch insulating film 193. Referring to FIG. 2, the touch protective film 197 is disposed only on the touch electrodes 195 and 196 and the touch insulating film 193. However, embodiments of the present disclosure are not limited thereto. The touch protective film 197 can extend to an inner end or an outer end of the dam DAM and thus can also be disposed on the touch electrode connection line 192.

Further, a color filter can be further disposed on the encapsulation layer 180, and the color filter can be positioned on the touch layer 190 or between the encapsulation layer 180 and the touch layer 190. Specifically, the color filter can be disposed above the third encapsulation layer 183 and disposed below the touch layer 190.

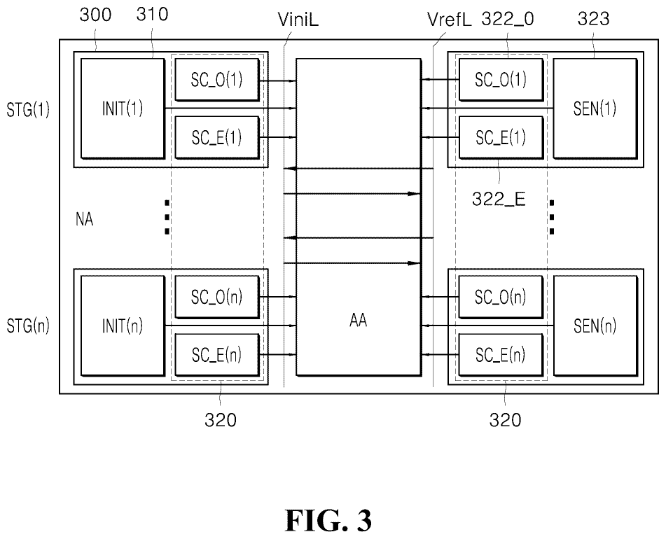

FIG. 3 is a diagram of a configuration of a gate driver in a display device according to an embodiment.

Referring to FIG. 3, a gate driver 300 includes a sensing signal driver 310 and a scan driver 320. The scan driver 320 can include odd-numbered scan drivers 322_O and even-numbered scan drivers 322_E.

The gate driver 300 can include shift registers which can be respectively disposed on both opposing sides of the display area AA symmetrically. Further, in the gate driver 300, the shift register on one side of the display area AA can be configured to include the scan drivers 322_O and 322_E, and the sensing signal driver 310. The shift register on the other side of the display area AA can be configured to include the scan drivers 322_O and 322_E, and an initialization driver 323. However, embodiments of the present disclosure are not limited thereto. The sensing signal driver 310, the scan drivers 322_O and 322_E, and the initialization driver 323 can be arranged in a manner varying according to embodiments. For example, in an embodiment, the sensing signal driver 310, the scan drivers 322_O and 322_E, and the initialization driver 323 can be arranged on one side of the display area AA or adjacent sides of the display area AA.

Each of stages STG (1) to STG (n) of the shift register can include each of scan signal generators SC_O(1) to SC_O(n) and SC_E(1) to SC_E(n), each of initialization signal generators INIT(1) to INIT(n), and each of sensing signal generators SEN(1) to SEN(n).

The scan signal generators SC(1) to SC(n) respectively output scan signals SC(1) to SC(n) via the scan lines SCL of the display panel 100. The initialization signal generators INIT(1) to INIT(n) respectively output initialization signals INIT(1) to INIT(n) through the initialization signal lines of the display panel 100. The sensing signal generators SEN(1) to SEN(n) respectively output sensing signals SEN(1) to SEN(n) through the sensing lines SENL of the display panel 100. Accordingly, each stage of the shift register can output scan signals, output initialization signals, and output sensing signals.

The scan signals SC(1) to SC(n) can be used as a signal to drive a second transistor (T2 in FIG. 5) included in the pixel circuit. The initialization signals INIT(1) to INIT(n) can be used as a signal to drive a first transistor (T1 in FIG. 5) included in the pixel circuit. The sensing signals SEN(1) to SEN(n) can be used as a signal to drive a third transistor (T3 in FIG. 5) included in the pixel circuit.

The initialization voltage bus line ViniL and the reference voltage bus line VrefL can be disposed between the gate driver 300 and the display area AA. The initialization voltage bus line ViniL and the reference voltage bus line VrefL can receive the initialization voltage Vini and the reference voltage Vref, respectively, from the power supply 500 and supply the received initialization voltage Vini and the received reference voltage Vref to the pixel circuit.

Referring to FIG. 3, the initialization voltage bus line ViniL is located only on one side (the left side) of the display area AA, and the reference voltage bus line VrefL is located only on the other side (the right side) of the display area AA. However, the present disclosure is not limited thereto. For example, in one embodiment the initialization voltage bus line ViniL can be located on each of both opposing side of the display area AA. The reference voltage bus line VrefL can be located on each of both opposing side of the display area AA. Alternatively, the initialization voltage bus line ViniL can be only on the other side (the right side) of the display area AA, and the reference voltage bus line VrefL can be located only on one side (the left side) of the display area AA.

Alternatively, in another embodiment, the initialization voltage bus line ViniL can be only on an upper side of the display area AA, while the reference voltage bus line VrefL can be located only on a lower side of the display area AA. Alternatively, in still another embodiment, the initialization voltage bus line ViniL can be located only on a lower side of the display area AA, while the reference voltage bus line VrefL can be located only on an upper side of the display area AA. Embodiments of the present disclosure are not limited thereto.

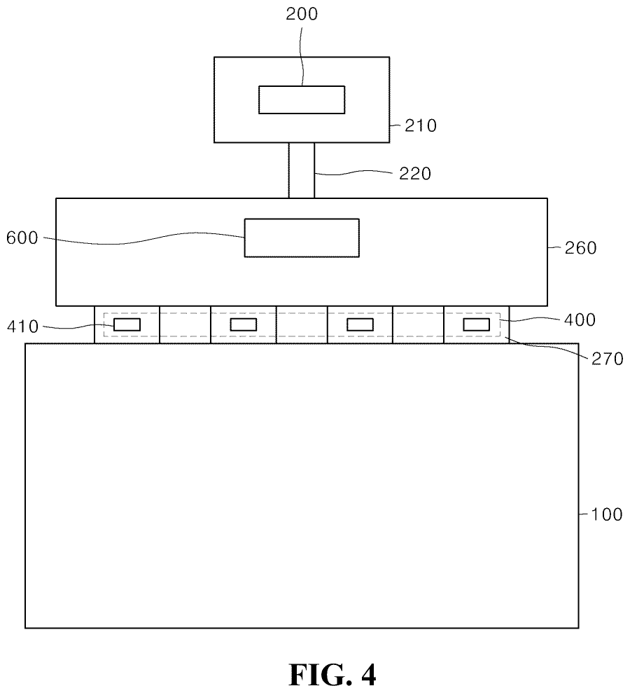

FIG. 4 is a plan view schematically showing a display device according to an embodiment of the present disclosure.

Referring to FIG. 4, the display device includes the display panel 100, the data driver 400, a source printed circuit board (SPCB) 260, the current sensor 600, the controller 200, and a control printed circuit board (CPCB) 210.

The data driver 400 can include multiple source drivers IC (Source Driver Integrated Circuit: SDIC) 410. Each of the source driver ICs 410 can be disposed on each of flexible films 270. In addition, the data driver 400 can include at least four source driver ICs 410. Accordingly, each source driver ICs 410 can be disposed on a respective flexible film 270.

Each of the flexible films 270 can be a tape carrier package or a chip on film. Each of the flexible films 270 can be bendable or flexible. Each of the flexible films 270 can be attached to a substrate of the display panel 100 and the source printed circuit board 260.

Additionally, each of the flexible films 270 can be attached to the substrate of the display panel 100 in a TAB (tape automated bonding) manner using an anisotropic conductive film. As a result, the source driver IC 410 can be electrically connected to the data lines.

Next, the source printed circuit board 260 can be connected to the control printed circuit board 210 via a flexible cable 220.

The current sensor 600 is configured to sense the driving current on a block basis of the display panel 100 in a sensing mode, and can convert the driving current into the sensing data Sdata as a digital signal, and provide the sensing data to the controller 200. The sensing mode can be performed before the display device is turned off. Alternatively, the sensing mode can be performed as soon as the display device is turned on. Alternatively, in another embodiment, the sensing mode can be performed at a regular interval while the display device is turned on.

FIG. 4 illustrates an example in which the controller 200 is provided in the control printed circuit board 210. However, embodiments of the present disclosure are not limited thereto. The controller 200 can be provided in the source printed circuit board 260. The controller 200 can receive the sensing data Sdata corresponding to the driving current from the current sensor 600 within the source printed circuit board 260, compensate for the image data based on the sensing data Sdata, and provide the compensated image data to the source driver IC 410.

FIG. 5 is a diagram of a pixel circuit in a display device according to an embodiment of the present disclosure.

FIG. 5 only shows an example of an embodiment of a pixel circuit. A structure of the pixel circuit is not limited particularly as long as the structure thereof can apply the scan signal SC(n) to the pixel to control the light-emission of the light-emitting element EL. For example, the pixel circuit can include a switching thin-film transistor (TFT) connected to an additional scan signal, and a switching thin-film transistor (TFT) to which an additional initialization voltage is applied. A connection relationship of the switching element or a connection position of the capacitor can vary. Hereinafter, for convenience of description, a display device with the pixel circuit structure of FIG. 5 is described in more detail.

Referring to FIG. 5, each of the plurality of pixels P can include a pixel circuit having a driving transistor DT, and the light-emitting element EL connected to the pixel circuit.

The pixel circuit can control the driving current flowing through the light-emitting element EL. Accordingly, the pixel circuit can be configured to drive the light-emitting element EL. In addition, the pixel, circuit can include the driving transistor DT, the first to third transistors T1 to T3, and the capacitor Cst. Each of the transistors DT, and T1 to T3 can include a first electrode, a second electrode, and a gate electrode. One of the first electrode and the second electrode can be a source electrode, and the other of the first electrode and the second electrode can be a drain electrode.

Each of the transistors DT, and T1 to T3 can be a P type thin-film transistor or an N type thin-film transistor. In the embodiment of FIG. 5, each of the transistors DT, and T1 to T3 is embodied as an N type thin-film transistor. However, the present disclosure is not limited thereto. According to an embodiment, each of all or some of the transistors DT, and T1 to T3 can be a P type thin-film transistor or an N type thin-film transistor. Furthermore, the N type thin-film transistor can be an oxide thin-film transistor. The P type thin-film transistor can be a polycrystalline silicon thin-film transistor.

Hereinafter, an example in which each of the transistors DT, and T1 to T3 is embodied as an N type thin-film transistor is described. Accordingly, each of the transistors DT, and T1 to T3 is turned on based on a high voltage applied thereto. However, the present disclosure is not limited thereto. For example, the transistors DT, and T1 to T3 can be embodied as a P type thin-film transistor.

According to one example, the first transistor T1 constituting the pixel circuit can function as an initialization transistor, the second transistor T2 constituting the pixel circuit can function as a data supply transistor, and the third transistor T3 constituting the pixel circuit can function as a sensing control transistor.

The light-emitting element EL can include an anode electrode and a cathode electrode. The anode electrode of the light-emitting element EL can be connected to a second node N2, and the cathode electrode can be connected to a low-potential driving voltage EVSS. The second node N2 can be connected to a source electrode of the driving transistor DT. The light-emitting element EL can include a capacitor Cel disposed between the anode electrode and the cathode electrode. The capacitor Cel can be a parasitic capacitor disposed between the anode electrode and cathode electrode of the light-emitting element EL. The capacitor Cel can have a capacitance value of the light-emitting element EL.

The driving transistor DT can include a drain electrode connected to a high potential driving voltage EVDD, a gate electrode connected to a first node N1, and a source electrode connected to the second node N2. The driving transistor DT can provide a driving current to the light-emitting element EL based on a voltage of the first node N1 (or the data voltage stored in the capacitor Cst, which will be described later).

The first transistor T1 can include a first electrode connected to the initialization voltage Vini, a second electrode connected to the first node N1, and a gate electrode receiving the initialization signal INI(n). Further, the first transistor T1 is turned on in response to the initialization signal INI(n) and thus can provide the initialization voltage Vini to the node N1. Accordingly, the first transistor T1 can be an initialization transistor.

The capacitor Cst can be connected to and disposed between the first node N1 and the second node N2. The capacitor Cst can sample and store therein or maintain the data voltage Vdata applied to the first node N1 and the second node N2.

The second transistor T2 can include a first electrode connected to the data line DL or receiving the data voltage Vdata, a second electrode connected to the first node N1, and a gate electrode receiving the scan signal SC(n). The second transistor T2 is turned on in response to the scan signal SC(n) and thus can transmit the data voltage Vdata to the second node N1. This second transistor T2 can be a data voltage supply transistor.

The third transistor T3 is connected to and disposed between the reference voltage Vref and the second node N2. The third transistor T3 can include a first electrode receiving the reference voltage Vref, a second electrode connected to the second node N2, and a gate electrode receiving the sensing signal SEN(n).

The third transistor T3 can perform a function of resetting the second node N2 through the reference voltage Vref in a display mode. Additionally, the third transistor T3 together with the driving transistor DT can establish a current flow path for driving current sensing in the sensing mode. In the sensing mode, the current flow path through the high potential driving voltage EVDD, a shunt resistor Rs, the driving transistor DT, the third transistor T3, and the reference voltage Vref can be established.

The light-emitting element EL can have the capacitor Cel disposed between the anode electrode and the cathode electrode. Specifically, the capacitor Cel can be disposed between anode of the light-emitting element EL, which is connected to the second node N2 and the cathode of the light-emitting element EL, which is connected to the low-potential driving voltage EVSS.

While the light-emitting element EL emits light, the capacitor Cel can be charged so that the anode electrode of the light-emitting element EL can have a specific voltage. Accordingly, an amount of charges accumulated in the light-emitting element EL can be reset by applying the reference voltage Vref to the anode electrode of the light-emitting element EL through the third transistor T3.

Each pixel P of the display panel 100 can drive the light-emitting element using one driving transistor DT and three switching transistors T1, T2, and T3. In addition, the current sensor 600 can be used to sense the driving current.

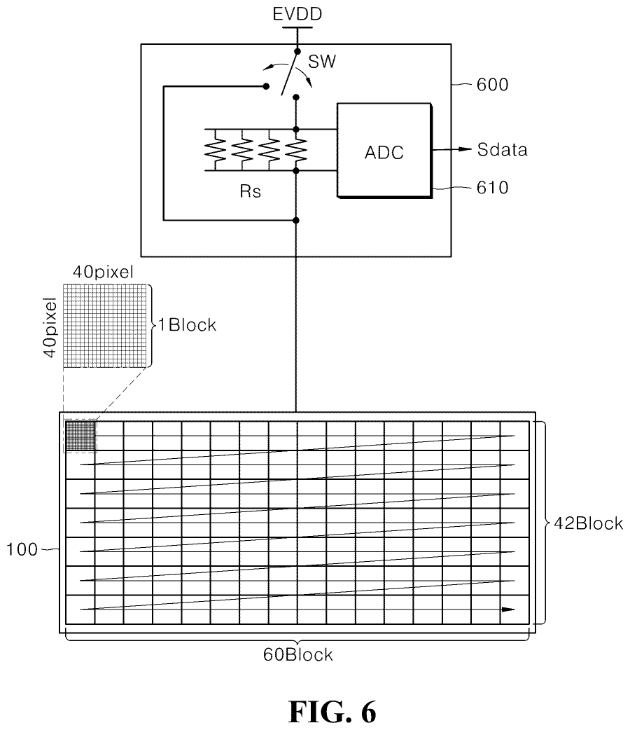

FIG. 6 is a diagram showing current sensing on a block basis of a display device according to an embodiment of the present disclosure.

Referring to FIG. 6, the current sensor 600 of the display device can sense the driving current on a block basis of the display panel 100. The current sensor 600 can sense the current flowing through the power line between the high-potential driving voltage EVDD and the display panel 100, and can convert the sensed current into the digital sensing data Sdata. The sensing data Sdata can be provided to the controller 200 which can compensate for degradation of the display panel 100 based on the sensing data Sdata.

Further, the current sensor 600 can be mounted in the source printed circuit board 260, can be connected to the controller 200 via the flexible cable 220, and can provide the sensing data Sdata to the controller 200 via the flexible cable 220.

The current sensor 600 can include a switch SW, the shunt resistance Rs, and an analog to digital converter (ADC) 610. One terminal of the switch SW can be connected to the high potential driving voltage EVDD, a first other terminal thereof can be connected to a power line that transmits the high potential driving voltage EVDD to the display panel 100, and a second other terminal thereof can be connected to the shunt resistor Rs. The switch SW can transfer the high-potential driving voltage EVDD to the display panel 100 in the display mode, and can transfer the high-potential driving voltage EVDD to the shunt resistor Rs in the sensing mode. Although one switch is illustrated in the drawing, the number of the switches is not limited thereto.

For example, the switch SW can transfer the high potential driving voltage EVDD to the display panel 100 or transfer the high potential driving voltage EVDD to the shunt resistor Rs based on a mode control signal provided from the controller 200. The mode control signal can be a logic signal indicating the display mode or the sensing mode. For example, if the switch SW is connected to the display panel 100 in the display mode, and the controller 200 transmits a control mode signal indicating a change in the control mode to the sensing mode, the switch SW will switch to connect to the shunt resistor Rs.

The switch SW can include at least one transistor including a gate electrode, a first electrode, and a second electrode. The mode control signal can be applied to the gate electrode, the first electrode can be connected to the high potential driving voltage EVDD, and the second electrode can be connected to the high potential driving voltage line of the display panel 100 or the shunt resistor Rs.

The shunt resistor Rs can include at least one resistor that drops the high potential driving voltage EVDD transmitted from the switch SW. The shunt resistance Rs can have a resistance value to drop the voltage level to a level at which the analog-to-digital converter 610 senses the current. In another embodiment, the shunt resistor Rs can include a plurality of resistors.

The analog-to-digital converter 610 can sense the current flowing through the shunt resistor Rs, and can convert the sensed current into the sensing data Sdata as the digital data and provide the sensing data to the controller 200. A value of the current flowing through the shunt resistor Rs can be determined based on a reference data voltage applied from the data driver 400 to the display panel 100. The data driver 400 can provide a first reference data voltage corresponding to a low potential current point and a second reference data voltage corresponding to a high potential current point to the display panel 100 via the data line in the sensing mode.

Additionally, the current sensor 600 can sense a first driving current according to the first reference data voltage on a block basis of the display panel 100, and can sense the second driving current according to the second reference data voltage on a block basis of the display panel 100. For example, one block unit can be set to an area of 40×40 pixels. The scan driver 300 can sequentially scan a plurality of block units, and the current sensor 600 can sense the driving current in each block unit under the scanning operation. However, in another embodiment, one block unit can be set to a different number of pixels.

Next, each of the multiple pixels P in the block unit of the display panel 100 can include the light-emitting element EL that is configured to emit light under the driving current, the driving transistor DT that controls the driving current and is connected to and disposed between the anode electrode of the light-emitting element EL and the high-potential power line, the capacitor Cst connected to and disposed between the gate electrode and the source electrode of the driving transistor DT, the first transistor T1 that initializes the gate electrode of the driving transistor DT in response to the initialization signal INI(n), the second transistor T2 that applies the data voltage Vdata corresponding to the image data or a preset reference data voltage to the gate electrode of the driving transistor DT in response to the scan signal SC(n), and the third transistor T3 that applies the reference voltage Vref to the source electrode of the driving transistor DT in response to the sensing signal SEN(n).

In one example, the reference voltage line to which the reference voltage Vref is applied can be connected to the scan lines (the gate lines) of the display panel 100 via the third transistor T3 of each pixel. Furthermore, an end of the reference voltage line can be in a floating state. During the sensing period, the sensing circuit 600 can sense the driving current in the current path established through the high potential driving voltage EVDD, the shunt resistor Rs, the driving transistor DT, the third transistor T3, and the reference voltage line.

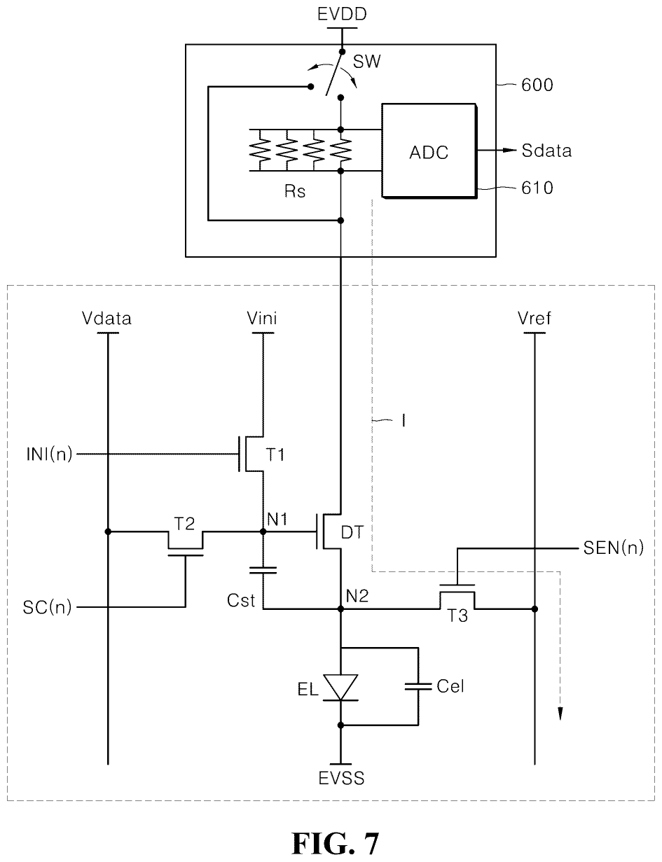

The operation of pixels in the sensing mode of the display device is described as follows. FIG. 7 is a diagram showing current sensing of a pixel within a block unit of a display device according to an embodiment of the present disclosure.

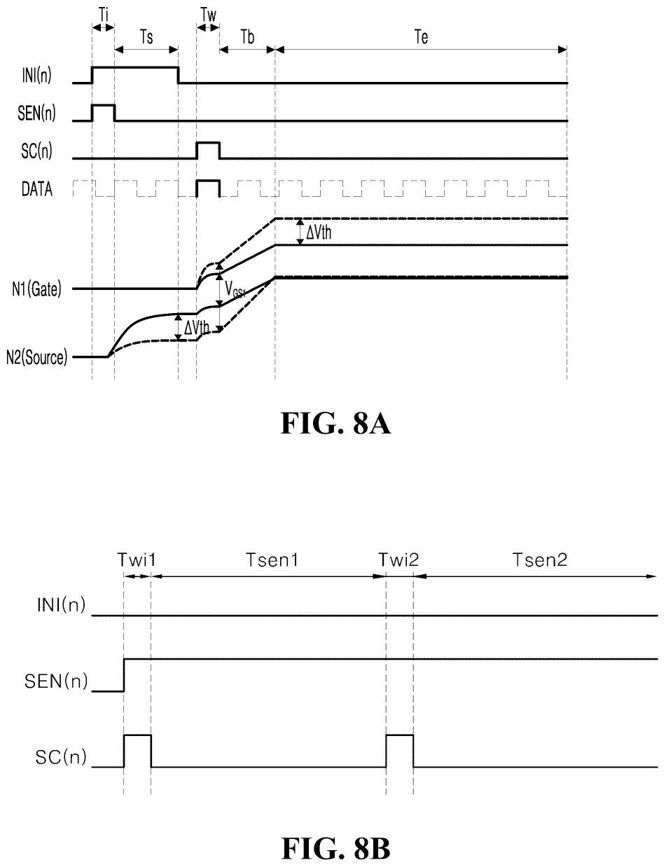

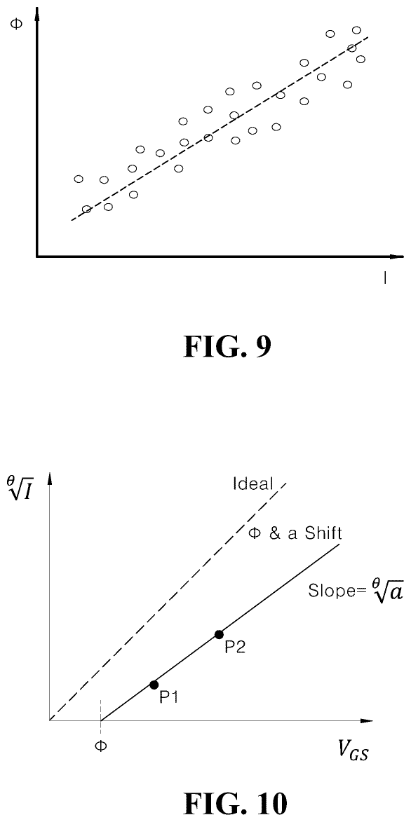

FIG. 8A is a timing diagram showing a display mode operation of a pixel circuit of a display device according to an embodiment of the present disclosure.

Referring to FIG. 7 and FIG. 8A, operation periods of the display device can include an initialization period Ti, a sensing period Ts, a writing period Tw, a boosting period Tb, and an emission period Te.

In the initialization period Ti, the first transistor T1 can apply the initialization voltage Vini to the gate electrode of the driving transistor DT in response to the initialization signal INI(n). Additionally, the third transistor T3 can apply the reference voltage Vref to the source electrode of the driving transistor DT in response to the sensing signal SEN(n).

In the sensing period Ts, the third transistor T3 can be turned off and the driving transistor DT can be turned on so that a threshold voltage Vth of the driving transistor can be sampled to the capacitor Cst. At this time, a voltage level of the second node N2 can rise according to the threshold voltage Vth sampled to the capacitor Cst. Next, in the writing period Tw, the second transistor T2 can transfer the data voltage Vdata to the capacitor Cst in response to the scan signal SC(n), thereby writing the data voltage Vdata therein.

In the boosting period Tb, the second transistor T2 can be turned off, and each of the voltages of the first node N1 and the second node N2 can be boosted based on the data voltage Vdata. In this regard, a difference between the voltages of the first node N1 and the second node N2 can be boosted based on a gate-source voltage VGS1 of the driving transistor DT. The gate-source voltage VGS1 of the driving transistor DT can have a predetermined value regardless of the threshold voltage Vth characteristics of the driving transistor DT in each pixel because the voltage of the first node N1 is canceled with the threshold voltage Vth sampled to the capacitor Cst. That is, the threshold voltage characteristics of the driving transistor DT can be internally compensated for in the boosting period Tb.

Next, in the emission period Te, the driving transistor DT can be turned on based on the boosted gate-source voltage VGS1, and the light-emitting element EL emits light based on the driving current corresponding to the data voltage Vdata.

FIG. 8B is a timing diagram showing a current sensing operation of a display device according to an embodiment of the present disclosure.

Referring to FIG. 7 and FIG. 8B, in the sensing mode, the display device can individually operate in a first initialization period Twi1, a first sensing period Tsen1, a second initialization period Twi2, and a second sensing period Tsen2.

In the sensing mode, the first initialization period Twi1 can be defined as a period for which the first reference data voltage corresponding to the low-current sensing point is written to the pixel and the pixel is initialized with the first reference data voltage. The first sensing period Tsen1 can be defined as a period for which the current of the pixel under the first reference data voltage is sensed.

In the first initialization period Twi1 of the sensing mode, the second transistor T2 can apply the first reference data voltage corresponding to the low-current sensing point to the gate electrode of the driving transistor DT, and the third transistor T3 can apply the reference voltage Vref to the source electrode of the driving transistor DT. In this regard, the first node N1 corresponding to the gate electrode of the driving transistor DT can maintain the level of the first reference data voltage, while the second node N2 corresponding to the source electrode of the driving transistor DT can maintain the level of the reference voltage Vref. The reference voltage Vref in the sensing mode can be set to a level lower than a level of a voltage across the light-emitting element EL.

In the first sensing period Tsen1 of the sensing mode, the second transistor T2 can be turned off, and the third transistor T3 can be maintained in the turned-on state. At this time, the first node N1 corresponding to the gate electrode of the driving transistor DT can maintain the level of the first reference data voltage, and the second node N2 corresponding to the source electrode of the driving transistor DT can maintain the level of the reference voltage Vref. The current sensor 600 can sense the first driving current under the first reference data voltage in the current path established through the high potential driving voltage EVDD, the shunt resistor Rs, the driving transistor DT, and the third transistor T3. The current sensor 600 can convert the first driving current into first sensing data and provide the first sensing data to the controller 200. Additionally, a duration of the first sensing period Tsen1 can be longer than a duration of the first initialization period Twi1.

Next, in the sensing mode, the second initialization period Twi2 can be defined as a period for which the second reference data voltage corresponding to the high current sensing point is written to the pixel and the pixel is initialized with the second reference data voltage. The second sensing period Tsen2 can be defined as a period for which the current of the pixel under the second reference data voltage is sensed.

In the second initialization period Twi2 of the sensing mode, the second transistor T2 can apply the second reference data voltage corresponding to the high current sensing point to the gate electrode of the driving transistor DT, and the third transistor T3 can apply the reference voltage Vref to the source electrode of the driving transistor DT. At this time, the first node N1 corresponding to the gate electrode of the driving transistor DT can maintain the level of the second reference data voltage, and the second node N2 corresponding to the source electrode of the driving transistor DT can maintain the level of the reference voltage Vref. The reference voltage Vref in the sensing mode can be set to a level lower than a level of the voltage across the light-emitting element EL.

In the second sensing period Tsen2 of the sensing mode, the second transistor T2 can be turned off, and the third transistor T3 can be maintained in the turned-on state. At this time, the first node N1 corresponding to the gate electrode of the driving transistor DT can maintain the level of the second reference data voltage, and the second node N2 corresponding to the source electrode of the driving transistor DT can maintain the level of the reference voltage Vref. The current sensor 600 can sense the second driving current under the second reference data voltage in the current path established through the high potential driving voltage EVDD, the shunt resistor Rs, the driving transistor DT, and the third transistor T3. The current sensor 600 can convert the second driving current into second sensing data and provide the second sensing data to the controller 200. Additionally, a duration of the second sensing period Tsen2 can be longer than a duration of the second initialization period Twi2.

Additionally, the current sensor 600 can sense the current of the pixel under the first or second reference data voltage applied to the pixel in the sensing mode, and can convert the sensed current into the sensing data Sdata.

The controller 200 can receive the first sensing data and the second sensing data respectively corresponding to the low-current sensing point and the high-current sensing point from the current sensor 600, and can calculate a first compensation factor and a second compensation factor for respectively compensating for the threshold voltage characteristics and the electron mobility characteristics of the driving transistor DT, based on the first sensing data and the second sensing data. Further, the controller 200 can calculate the first compensation factor and the second compensation factor on a preset block basis of the display panel 100 and compensate for the image data to be displayed on the display panel 100 based on the first compensation factor and the second compensation factor.

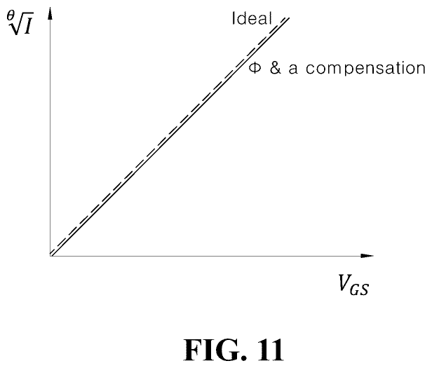

FIGS. 9 to 11 are diagrams schematically showing a principle of compensating for the degradation characteristics of the display panel based on the sensing data in a display device according to an embodiment of the present disclosure.

The controller 200 can analyze a linear tendency between a current value I and an offset value on a block basis of the display panel 100 and calculate a compensation factor to compensate for degradation on a block basis. A table indicating a relationship between the offset value Φ and the current value I can be stored in a memory of the display device. The offset value Φ based on the current value I can be used as the compensation factor to compensate for the characteristics of the threshold voltage Vth of the driving transistor of the pixel.

The controller 200 can receive the first and second sensing data respectively corresponding to the low-current sensing point P1 and the high-current sensing point P2 from the current sensor 600. Each of the first sensing data and the second sensing data can include data about the sensed current value, a voltage value calculated based on the sensed current value, and a power value calculated based on the current value and the voltage value.

The controller 200 can calculate a current value and a voltage value corresponding to each of the low-current sensing point P1 and the high-current sensing point P2, and can calculate the offset value Φ and a slope value a based on a following <Equation 1> which represents a linear relationship between the current and voltage values.

$$\sqrt[θ]{I} = \sqrt[θ]{α} \times ( {V}_{GS} - Φ ) \qquad Equation 1$$

Where I represents the driving current of the driving transistor DT, VGS represents the gate-source voltage of the driving transistor DT, Φ represents the offset value corresponding to the sensed current I, and α represents the slope in the linear relationship between the current and the voltage. θ can be defined as a value to make the measured or calculated I or α a linear value.

Next, the controller 200 can calculate the offset value Φ in a manner expressed in a following <Equation 2> based on the <Equation 1>.

$$Φ = \frac{\sqrt[θ]{{I}_{1}} \times {V}_{GS 2} - \sqrt[θ]{{I}_{2}} \times {V}_{GS 1}}{\sqrt[θ]{{I}_{1}} - \sqrt[θ]{{I}_{2}}} \qquad Equation 2$$

Where I1 and VGS1 represents a value measured at the low current sensing point P1, and each of I2 and VGS2 represents a value measured at the high current sensing point P2.

Furthermore, the controller 200 can calculate the slope value a in a manner expressed in a following <Equation 3> based on the <Equation 1>.

$$α = {( \frac{\sqrt[θ]{{I}_{2}} - \sqrt[θ]{{I}_{1}}}{{V}_{GS 2} - {V}_{GS 1}} )}^{θ} \qquad Equation 3$$

Where I1 and VGS1 represents a value measured at the low current sensing point P1, and each of I2 and VGS2 represents a value measured at the high current sensing point P2.

The calculated offset value Φ can be used as the first compensation factor to compensate for the threshold voltage Vth of the driving transistor, and the calculated slope value a can be used as the second compensation factor to compensate for the electronic mobility of the driving transistor.

Accordingly, the controller 200 can calculate the offset value Φ and the slope value a to respectively compensate for the threshold voltage characteristics and the electron mobility characteristics of the driving transistor DT based on the first and second sensing data respectively corresponding to the low-current sensing point P1 and the high-current sensing point P2.

The controller 200 can calculate the compensation data on a preset block basis of the display panel 100 based on the offset value Φ and the slope value a. A table indicating a relationship between the compensation data value and the offset value Φ and the slope value a can be stored in the memory of the display device.

The controller 200 can compensate the image data to be displayed on the display panel 100 using the compensation data corresponding to the offset value Φ and the slope value a on a block basis stored in the memory in the display mode.

Accordingly, the display device can reduce a degradation compensation error by simultaneously compensating for the threshold voltage characteristics and the electron mobility characteristics of the driving transistor of the display panel. Furthermore, the display device can improve spot defects in the display panel by reducing the degradation compensation error on a block basis. Additionally, the display device can accurately display an image at a target gray scale and luminance by reducing the influence of the threshold voltage characteristics and the electron mobility characteristics of the driving transistor. Accordingly, the image quality can be improved. Further, the display device can drive the light-emitting element EL with one driving transistor DT and the three switching transistors T1, T2, and T3 which can be used to sense the driving current. Thus, when the display device of the present disclosure is applied to a transparent display device, a transmissive area can be increased.

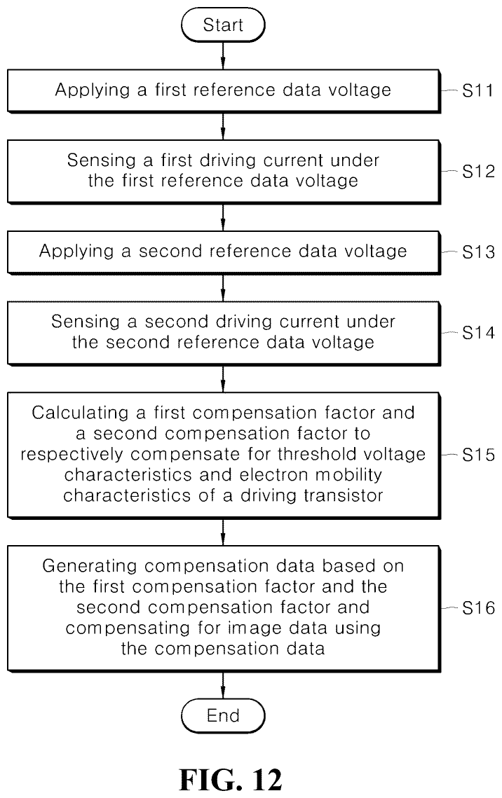

FIG. 12 is a flowchart showing a method for compensating for degradation of a display device according to an embodiment of the present disclosure.

Referring to FIG. 12, in the method for compensating for the degradation of the display device, first, the display device applies the first reference data voltage corresponding to the low-current sensing point P1 to the display panel 10 in the sensing mode in S11.

Next, the display device senses the first driving current in the current path established when the driving transistor DT is turned on under the first reference data voltage on a block basis of the display panel 10 in S12.

The display device converts the first driving current sensed at the low-current sensing point P1 on a block basis into the first sensing data.

Then, the display device applies the second reference data voltage corresponding to the high current sensing point P2 to the display panel 100 in the sensing mode in S13.

Next, the display device senses the second driving current in the current path established when the driving transistor DT is turned on under the second reference data voltage on a block basis of the display panel 10 in S14.

The display device converts the second driving current sensed at the high current sensing point P2 on a block basis into the second sensing data.

Subsequently, the display device calculates the first compensation factor and the second compensation factor to respectively compensate for the threshold voltage characteristics and the electron mobility characteristics of the driving transistor DT based on the first sensing data and the second sensing data in S15.

In the display mode, the display device generates the compensation data to compensate for the image data based on the first compensation factor and the second compensation factor and compensates for the image data using the compensation data in S16.

A display device according to various aspects and features of the present disclosure can be described as follows.

A first aspect of the present disclosure can provide a display device including a display panel including a plurality of pixels, and a data driver configured to a reference data voltage to the display panel in a sensing mode, and a current sensor configured to in the sensing mode, lower a high potential driving voltage supplied to the display panel, sense a driving current of the display panel under the reference data voltage and the lowered driving voltage, and convert the sensed driving current into sensing data.

According to some features of the display device of the first aspect, in the sensing mode, the data driver can be configured to apply, to the display panel, at least one of a first reference data voltage corresponding to the low current sensing point and a second reference data voltage corresponding to the high current sensing point.

According to some features of the display device of the first aspect, in the sensing mode, the current sensor can be configured to sense a first driving current and a second driving current under the first reference data voltage and the second reference data voltage, respectively, and convert the first driving current and the second driving current to a second driving current and a second sensing data, respectively.

According to some features of the display device of the first aspect, the current sensor can be configured to sense the driving current corresponding to at least one of the low-current sensing point and the high-current sensing point on a preset block basis of the display panel.

According to some features of the display device of the first aspect, the current sensor can include a switch configured to transmit the high-potential driving voltage to the display panel in a display mode and transmit the high-potential driving voltage to a shunt resistor in the sensing mode, the shunt resistor configured to lower the high-potential driving voltage transmitted thereto through the switch to a voltage level adapted to sense the driving current, and an analog-to-digital converter configured to sense the driving current based on a voltage across the shunt resistor and convert the sensed driving current into the sensing data.

According to some features of the display device of the first aspect, each of the plurality of pixels can include a light-emitting element for emitting light in response to the driving current, a driving transistor configured to control the driving current and connected to and disposed between an anode electrode of the light-emitting element and a high-potential power line, a capacitor connected to and disposed between a gate electrode and a source electrode of the driving transistor, a first transistor configured to initialize the gate electrode of the driving transistor in response to an initialization signal, a second transistor configured to apply a data voltage corresponding to image data or the reference data voltage to the gate electrode of the driving transistor in response to a scan signal, and a third transistor configured to apply a reference voltage to the source electrode of the driving transistor in response to a sensing signal.

According to some features of the display device of the first aspect, the display device can further include a controller configured to calculate a first compensation factor and a second compensation factor for respectively compensating for threshold voltage characteristics and electron mobility characteristics of the driving transistor, respectively based on first sensing data and second sensing data respectively corresponding to the low-current sensing point and the high-current sensing point.

According to some features of the display device of the first aspect, the controller can be configured to calculate the first compensation factor and the second compensation factor on a preset block basis of the display panel and to store the first compensation factor and the second compensation factor in a memory.

According to some features of the display device of the first aspect, in a display mode, the controller can be configured to generate compensation data based on the first compensation factor and the second compensation factor stored in the memory, and to compensate for image data using the compensation data.

According to some features of the display device of the first aspect, the display device can operate in the sensing mode for a preset time duration when the display device is powered on or off.

A second aspect of the present disclosure can provide a method for compensating for degradation of a display device, the method can include in a sensing mode, applying a first reference data voltage corresponding to a low-current sensing point to a display panel, sensing a first driving current under the first reference data voltage, converting the first driving current into first sensing data, in the sensing mode, applying a second reference data voltage corresponding to a high current sensing point to the display panel, sensing a second driving current under the second reference data voltage, converting the second driving current into second sensing data, receptively calculating a first compensation factor and a second compensation factor for compensating for threshold voltage characteristics and electron mobility characteristics of a driving transistor, based on the first sensing data and the second sensing data, respectively, and in a display mode, generating compensation data based on the first compensation factor and the second compensation factor, and compensating for image data using the compensation data.

According to some features of the method of the second aspect, the sensing of the first driving current can include sensing the first driving current at the low current sensing point on a preset block basis of the display panel, wherein the sensing of the second driving current includes sensing the second driving current at the high current sensing point on the preset block basis of the display panel.

According to some features of the method of the second aspect, the calculating of the first compensation factor and the second compensation factor can include calculating the first compensation factor and the second compensation factor on a preset block basis of the display panel.

A third aspect of the present disclosure can provide a display device including a display panel including a plurality of pixels, and a current sensor configured to in a sensing mode, sense a driving current of the display panel under a reference data voltage on a preset block basis of the display panel, and convert the sensed driving current into sensing data, wherein each of the plurality of pixels includes: a light-emitting element for emitting light in response to the driving current, a driving transistor configured to control the driving current and connected to and disposed between an anode electrode of the light-emitting element and a high-potential power line, a capacitor connected to and disposed between a gate electrode and a source electrode of the driving transistor, a first transistor configured to initialize the gate electrode of the driving transistor in response to an initialization signal, a second transistor configured to apply a data voltage corresponding to image data or the reference data voltage to the gate electrode of the driving transistor in response to a scan signal, and a third transistor configured to apply a reference voltage to the source electrode of the driving transistor in response to a sensing signal.

According to some features of the display device of the third aspect, in a first initialization period of the sensing mode, the second transistor can be configured to apply a first reference data voltage corresponding to a low-current sensing point to the gate electrode of the driving transistor, and the third transistor is configured to apply the reference voltage to the source electrode of the driving transistor.

According to some features of the display device of the third aspect, in a first sensing period of the sensing mode, the second transistor can be turned off, the third transistor can be maintained at a turned-on state, and the current sensor can be configured to sense a first driving current under the first reference data voltage.

According to some features of the display device of the third aspect, in a second initialization period of the sensing mode, the second transistor can be configured to apply a second reference data voltage corresponding to a high current sensing point to the gate electrode of the driving transistor, and the third transistor can be configured to apply the reference voltage to the source electrode of the driving transistor.

According to some features of the display device of the third aspect, in a second sensing period of the sensing mode, the second transistor can be turned off, the third transistor can be maintained at a turned-on state, and the current sensor can be configured to sense a second driving current under the second reference data voltage.

According to some features of the display device of the third aspect, the display device can further include a controller configured to receive first sensing data and second sensing data respectively corresponding to a low-current sensing point and a high-current sensing point from the current sensor, and calculate a first compensation factor and a second compensation factor for respectively compensating for threshold voltage characteristics and electron mobility characteristics of the driving transistor, based on the first sensing data and the second sensing data, respectively.

According to some features of the display device of the third aspect, the controller can be configured to generate compensation data based on the first compensation factor and the second compensation factor, and to compensate for image data based on the generated compensation data.

Although embodiments of the present disclosure have been described with reference to the accompanying drawings, the present disclosure is not limited to the above embodiments, but can be implemented in various different forms. A person skilled in the art can appreciate that the present disclosure can be practiced in other concrete forms without changing the technical spirit or essential characteristics of the present disclosure. Therefore, it should be appreciated that the embodiments as described above is not restrictive but illustrative in all respects.

What is claimed is:

1. A display device comprising:
a display panel including a plurality of pixels;
a data driver configured to apply a reference data voltage to the display panel in a sensing mode;
a current sensor configured to:
in the sensing mode,
lower a high potential driving voltage supplied to the display panel;
sense a driving current of the display panel while the reference data voltage and the lowered driving voltage are applied; and
convert the sensed driving current into sensing data; and
a controller configured to calculate a compensation factor based on the sensing data,
wherein, in a display mode, the compensation factor is used to compensate image data.

2. The display device of claim 1, wherein in the sensing mode, the data driver is configured to apply, to the display panel, at least one of a first reference data voltage corresponding to a low current sensing point and a second reference data voltage corresponding to a high current sensing point.

3. The display device of claim 2, wherein, in the sensing mode, the current sensor is further configured to:
sense a first driving current and a second driving current under a first reference data voltage and a second reference data voltage, respectively; and
convert the first driving current and the second driving current to a first sensed data and a second sensing data, respectively.

4. The display device of claim 1, wherein the current sensor is further configured to sense the driving current corresponding to at least one of a low current sensing point and a high current sensing point based on a preset block basis of the display panel.

5. The display device of claim 1, wherein the current sensor includes:
a switch configured to transmit the high potential driving voltage to the display panel in the display mode and transmit the high potential driving voltage to a shunt resistor in the sensing mode;
a shunt resistor configured to lower the high potential driving voltage transmitted thereto through the switch to a voltage level where the driving current is capable of being sensed; and
an analog-to-digital converter configured to sense the driving current based on a voltage across the shunt resistor and configured to convert the sensed driving current into the sensing data.

6. The display device of claim 1, wherein each of the plurality of pixels includes:
a light-emitting element comprising an anode electrode and a cathode electrode, the light-emitting element being configured to emit light in response to the driving current;
a driving transistor comprising a gate electrode and a source electrode, the driving transistor being configured to control the driving current and connected to the anode electrode of the light-emitting element and a high-potential power line;
a capacitor connected to the gate electrode and the source electrode of the driving transistor;
a first transistor configured to initialize the gate electrode of the driving transistor in response to an initialization signal;
a second transistor configured to apply a data voltage corresponding to the image data or the reference data voltage to the gate electrode of the driving transistor in response to a scan signal; and
a third transistor configured to apply a reference voltage to the source electrode of the driving transistor in response to a sensing signal.

7. The display device of claim 6, wherein the controller is further configured to calculate a first compensation factor and a second compensation factor for respectively compensating for threshold voltage characteristics and electron mobility characteristics of the driving transistor, respectively based on first sensing data and second sensing data respectively corresponding to a low current sensing point and a high current sensing point.

8. The display device of claim 7, wherein the controller is configured to calculate the first compensation factor and the second compensation factor based on a preset block basis of the display panel and is configured to store the first compensation factor and the second compensation factor in a memory.

9. The display device of claim 7, wherein in the display mode, the controller is configured to generate compensation data based on the first compensation factor and the second compensation factor stored in a memory, and is configured to compensate for the image data using the compensation data.

10. The display device of claim 1, wherein the display device operates in the sensing mode for a preset time duration when the display device is powered on or off.

11. A method for compensating for degradation of a display device, the method comprising:
in a sensing mode, applying a first reference data voltage corresponding to a low current sensing point to a display panel;
sensing a first driving current while the first reference data voltage is applied;
converting the first driving current into first sensing data;
applying a second reference data voltage corresponding to a high current sensing point to the display panel;
sensing a second driving current while the second reference data voltage is applied;
converting the second driving current into second sensing data;
calculating a first compensation factor and a second compensation factor for compensating for threshold voltage characteristics and electron mobility characteristics of a driving transistor, based on the first sensing data and the second sensing data, respectively; and
in a display mode, generating compensation data based on the first compensation factor and the second compensation factor, and compensating for image data using the compensation data.

12. The method of claim 11, wherein the sensing of the first driving current includes sensing the first driving current at the low current sensing point based on a preset block basis of the display panel, and
wherein the sensing of the second driving current includes sensing the second driving current at the high current sensing point based on the preset block basis of the display panel.

13. The method of claim 12, wherein the calculating of the first compensation factor and the second compensation factor includes calculating the first compensation factor and the second compensation factor based on the preset block basis of the display panel.

14. A display device comprising:
a display panel including a plurality of pixels; and
a current sensor configured to:
in a sensing mode,
sense a driving current of the display panel while a reference data voltage is applied based on a preset block basis of the display panel; and
convert the sensed driving current into sensing data,
wherein each of the plurality of pixels includes:
a light-emitting element comprising an anode electrode and a cathode electrode, the light-emitting element being configured to emit light in response to the driving current;
a driving transistor comprising a gate electrode and a source electrode, the driving electrode being configured to control the driving current and connected to the anode electrode of the light-emitting element and a high-potential power line;
a capacitor connected to the gate electrode and the source electrode of the driving transistor;
a first transistor configured to initialize the gate electrode of the driving transistor in response to an initialization signal;
a second transistor configured to apply a data voltage corresponding to image data or the reference data voltage to the gate electrode of the driving transistor in response to a scan signal; and
a third transistor configured to apply a reference voltage to the source electrode of the driving transistor in response to a sensing signal.

15. The display device of claim 14, wherein in a first initialization period of the sensing mode, the second transistor is configured to apply a first reference data voltage corresponding to a low current sensing point to the gate electrode of the driving transistor, and the third transistor is configured to apply the reference voltage to the source electrode of the driving transistor.

16. The display device of claim 15, wherein in a first sensing period of the sensing mode, the second transistor is turned off, the third transistor is maintained at a turned-on state, and the current sensor is configured to sense a first driving current while the first reference data voltage is applied.

17. The display device of claim 14, wherein in a second initialization period of the sensing mode, the second transistor is configured to apply a second reference data voltage corresponding to a high current sensing point to the gate electrode of the driving transistor, and the third transistor is configured to apply the reference voltage to the source electrode of the driving transistor.

18. The display device of claim 17, wherein in a second sensing period of the sensing mode, the second transistor is turned off, the third transistor is maintained at a turned-on state, and the current sensor is configured to sense a second driving current while the second reference data voltage is applied.

19. The display device of claim 14, wherein the display device further comprises a controller configured to:
receive first sensing data and second sensing data respectively corresponding to a low current sensing point and a high current sensing point from the current sensor; and
calculate a first compensation factor and a second compensation factor for respectively compensating for threshold voltage characteristics and electron mobility characteristics of the driving transistor, based on the first sensing data and the second sensing data, respectively.

20. The display device of claim 19, wherein the controller is configured to generate compensation data based on the first compensation factor and the second compensation factor, and is configured to compensate for the image data based on the generated compensation data.

21. A display device comprising:
a display area comprising at least one light-emitting element;
a non-display area disposed outside of the display area;
at least one thin-film transistor disposed under the display area;
an encapsulation layer configured to block foreign substances from reaching the at least one light-emitting element; and
a controller configured to receive sensing data, and compensate image data based on the received sensing data,
wherein the at least one thin-film transistor is configured to drive the at least one light-emitting element based on the compensated image data.

22. The display device of claim 21, further comprising a current sensor configured to, in a sensing mode, sense a driving current of a display panel while a reference data voltage is applied, and convert the sensed driving current into the sensing data
wherein the current sensor transmits the sensing data to the controller.

23. The display device of claim 21, wherein the encapsulation layer comprises:
a first encapsulation layer disposed on the at least one light-emitting element;
a second encapsulation layer disposed on the first encapsulation layer and configured to absorb external forces to the display device; and
a third encapsulation layer disposed on the second encapsulation layer and configured to encapsulate the second encapsulation layer by connecting with the first encapsulation layer,
wherein the first encapsulation layer, the second encapsulation layer, and the third encapsulation layer are each disposed in both the display area and the non-display area.

24. The display device of claim 23, further comprising at least one dam configured to prevent the second encapsulation layer from reaching an edge of the non-display area.
